(19) United States
(12) Patent Application Publication
(10) Pub. No.: US 2016/0169282 A1
(43) Pub. Date: Jun. 16, 2016

(54) ROLLER BEARING AND METHOD FOR ASSEMBLING A ROLLER BEARING

(71) Applicants: Nils MANNE, Goteborg (SE); Christophe BAILLIE, Genas (FR); Alexandre MANCEAU, Tournon sur Rhone (FR)

(72) Inventors: Nils MANNE, Goteborg (SE); Christophe BAILLIE, Genas (FR); Alexandre MANCEAU, Tournon sur Rhone (FR)

(21) Appl. No.: 14/436,551

(22) PCT Filed: Sep. 30, 2013
(86) PCT No.: PCT/SE2013/000151

§ 371 Date: Apr. 17, 2015

(30) Foreign Application Priority Data
Oct. 19, 2012 (SE) 1200644-1

(51) Int. Cl. F16C 33/58; F16C 19/38; F16C 43/04; F16C 33/78

(52) U.S. Cl. CPC F16C 33/585; F16C 33/7843; F16C 19/38; F16C 43/04

(57) ABSTRACT

A roller bearing according to an embodiment comprises a first roller bearing ring comprising at least one raceway, a second roller bearing ring comprising at least one raceway, a plurality of rolling elements arranged between the raceways of the first roller bearing ring and the second roller bearing ring and at least one retaining flange detachably mounted onto the first roller bearing ring. Employing an embodiment may simplify at least one of manufacturing and assembling the roller bearing.

### CROSS REFERENCE TO RELATED APPLICATIONS

This is a United States National Stage Application claiming the benefit of International Application Number PCT/SE2013/000151 filed on 30 Sep. 2013 (30.09.2013), which claims the benefit of Sweden (SE) Patent Application 1200644-1, field on 19 Oct. 2012 (19.10.2012), both of which are incorporated herein by reference in their entireties.

### FIELD OF THE INVENTION

Embodiments relate to a roller bearing, such as a spherical roller bearing, and a method for assembling a roller bearing.

### PRIOR ART

Roller bearings are widely used in mechanical engineering disciplines to guide rotating components with respect to one another. Examples come, for instance, from the fields of the vehicle construction as well as plant construction and engine constructions to name but a few. In many examples a shaft, for instance a drive shaft, a propeller shaft or a Cardan shaft, is guided with respect to a housing or another fixed component. In these cases, the shaft is often mechanically coupled to an inner ring of a roller bearing, while an outer ring of the roller bearing is coupled to the housing.

However, in other fields of applications, also the outer ring may be coupled to a rotating component. In this case, the inner ring may be coupled to a fixed component or another rotating component and, thereby, mitigating a relative movement between the respective components.

In the case of a roller bearing, rolling elements are disposed or arranged between the inner and the outer roller bearing rings in such a way that these are capable of rolling on raceways of the two roller bearing rings, when the roller bearing rings are turned relatively with respect each other around a common axis of the roller bearing.

In this context a number of challenges often need to be addressed depending on the application in mind and its circumstances, such as temperatures, temperature variations, mechanical misalignments, vibrations and mechanical strain. A number of different roller bearing types exist, which are capable of handling different challenges and circumstances. In many cases though, the rolling elements disposed between the two roller bearing rings need to be guided at least partially along a direction for responding to that of the axis of the roller bearing. To enable guiding the rollers different techniques may be used. For instance, a retaining flange structure may be implemented to guide the rollers directly or indirectly, for instance, via a cage of the rollers. However, also for other reasons retaining flanges may be implemented, for instance, to implement a self-retaining roller bearing or a roller bearing allowing a limited axial movement of the roller bearing rings only.

However, manufacturing retaining flange structures and integrating them into roller bearing rings often poses a significant challenge in terms of manufacturing the roller bearing rings. Depending on a concrete implementation of the manufacturing process, special steps need to be taken into account when, for instance, soft mashing and hard turning the respective roller bearing rings. The same also applies to the step of manufacturing the roller bearing from its components. Due to its intention of guiding the rolling elements, the retaining flange structure integrated into the roller bearing rings may constrict assembling the roller bearing.

Therefore, a demand exists to simplify manufacturing and/or assembling a roller bearing.

### OBJECT AND BRIEF SUMMARY OF THE INVENTION

This demand is met by a roller bearing according to claim 1 and a method for assembling a roller bearing according to claim 10.

According to an embodiment, a roller bearing comprises a first roller bearing ring comprising at least one raceway, a second roller bearing ring comprising at least one raceway, a plurality of rolling elements arranged between the raceways of the first roller bearing ring and the second roller bearing ring, and at least one retaining flange to detachably mounted onto the first roller bearing ring.

Accordingly, an embodiment of a method for assembling a roller bearing comprises providing a first roller bearing ring comprising at least one raceway, providing a second roller bearing ring comprising at least one raceway, arranging a plurality of rolling elements between the raceways of the first roller bearing ring and the second roller bearing ring, and the detachably mounting at least one retaining flange onto the first roller bearing ring.

The rolling elements may be disposed or arranged between the raceways of the first and second roller bearing rings in such way that they are capable of rolling on the raceways of the first and second roller bearing rings, when the first and second roller bearing rings are turned relatively with respect to each other around an axis of the roller bearing. Optionally, the at least one retaining flange may be adapted to guide the rolling elements along at least one direction of the axis of the roller bearing directly or indirectly, for instance, via an optional cage of the roller bearing. However, a retaining ring may also be included for other reasons, for instance, to make the roller bearing self-retaining. Detachably mounting may include the option of re-installing the retaining flange after removing, detaching or de-assembling the retaining ring from first roller bearing ring.

In the case a method for assembling a roller bearing, it may be advisable to detachably mount the at least one retaining flange onto the first roller bearing ring after arranging the plurality of rolling elements between the raceways of the first and second roller bearing rings to facilitate an easier manufacturing or assembling of the roller bearing.

An embodiment of a roller bearing as well as an embodiment of a method for assembling a roller bearing is based on the finding that the manufacturing and/or assembling a roller bearing may be simplified by replacing the retaining flange of a conventional roller bearing with detachably mounted one. By doing so, a necessity to include and to implement the retaining flange into the first roller bearing ring no longer exists and therefore the manufacturing process of the first roller bearing ring may be simplified. Moreover, as will be laid out below and more detailed, the retaining flange may be manufactured by using relatively simple construction means. Furthermore, it may be possible to simplify assembling the roller bearing simply by the fact that the retaining flange is not needed to be included when the plurality of rolling elements is arranged between the raceways of the first and second roller bearing rings.

The raceways of the first and second roller bearing rings may optionally be subject to a surface treatment or another corresponding treatment. For instance, the raceways of the first and second roller bearing rings may be manufactured to a higher tolerance class, may comprise a certain surface hardening, a surface coating or a similar treatment.

Optionally, in a roller bearing according to an embodiment, the at least one retaining flange may comprise at least one ring segment or a ring having a L-shaped cross-section along a plain perpendicular to a circumferential direction of the roller bearing. In other words, the roller bearing may have a comparably simple form of a ring or ring segment with an L-shaped cross-section, which can simplify manufacturing of the retaining flange even further.

Optionally, a roller bearing according to an embodiment, the at least one retaining flange may be formed from a bent metal sheet or a plastic material. Both alternatives represent comparably simple manufacturing processes by the means of which the retaining flange can easily and cost-efficiently be formed. Therefore, manufacturing and/or assembling a roller bearing according to an embodiment may further be simplified.

Optionally, in a roller bearing according to an embodiment, the at least one retaining flange may be force-fittingly, form-fittingly and/or adhesively coupled, for instance by gluing, to the first roller bearing ring. A force-fitted coupling or a friction-based contact is based on establishing friction between the two components involved. In contrast an adhesively-based bonding, which is also referred to as an adhesive bonding, is based on a establishing a molecular or atomic interaction of the two components, for instance, by welding, soldering and gluing or another immediate or mediated bonding by molecular or atomic forces. A form-fitted coupling is based on a geometric interaction of the respective components. In other words, a force-fitted coupling or a friction-based contact is based on establishing a normal force perpendicular to the touching surfaces of the respective components. Force-fittingly coupling the at least one retaining flange to the first roller bearing ring may therefore further simplify assembling the roller bearing.

Optionally in a roller bearing according to an embodiment, the first roller bearing ring may comprise at least one surface and/or recess adapted to accommodate the at least one retaining flange. The surface or recess may form an edge with respect to the raceway to allow an easier positioning of the retaining flange, simplifying assembling the roller bearing further.

Optionally, in a roller bearing according to an embodiment, the at least one surface may be formed in a recess extending from outer edge of the first roller bearing ring to the raceway of a first roller bearing. As a consequence, the recess may form the previously mentioned edge with respect to the raceway allowing an easier positioning of the at least one retaining flange. It may also simplify manufacturing of the first roller bearing ring by avoiding fabricating more complex structures. The edge may essentially be oriented perpendicular to the axis of the roller bearing.

Alternatively or additionally, the at least one surface or recess may essentially be oriented perpendicular to a radial direction the roller bearing. In other words, the at least one recess may have a cylindrical surface with an essentially constant radius. This may also simplify detachably mounting the retaining flange and, therefore, assembling the roller bearing.

Optionally, in a roller bearing according to an embodiment, the first and second roller bearing rings may each comprise at least two raceways. The plurality of rolling elements may be arranged between each of the at least two raceways of the first and second roller bearing rings. In other words, the roller bearing may comprise at least two rows of rolling elements disposed between the raceways of the first and second roller bearing rings. A roller bearing comprising more than one row of rolling elements may especially be interesting to be implemented as an embodiment. In these cases, the arrangement of the rolling elements may additionally increase the challenge of manufacturing and/or assembling the roller bearing in a cost-efficient manner.

For instance, a roller bearing according to an embodiment may be implemented as a spherical roller bearing, for instance, as a CA-type spherical roller bearing. In such a case, it may be advisable to implement the roller bearing according to an embodiment comprising at least two retaining flanges oriented at two opposing edges of the first roller bearing ring.

A roller bearing according to an embodiment may further comprise at least one elastomer structure adapted to seal at least partially a volume between the first and second roller bearing rings. The at least one elastomer structure is mechanically fixed to the second roller bearing ring and in contact with a sealing surface of the at least one retaining flange. Alternatively or additionally, the at least one elastomer structure may be mechanically fixed, for instance by an adhesively bonding, to the at least one retaining flange and adapted to be in contact with the sealing surface of the second roller bearing ring. The sealing surface of the first roller bearing ring or of the second roller bearing ring may, but do not have to be treated differently from other surface sections of the respective roller bearing ring or the at least one retaining flange. In other words, the sealing surface may in some embodiments be implemented as a section of the surface of the retaining flange or the second roller bearing ring, respectively, which is simply suitably arranged to allow the elastomer structure to be in contact with it. In other embodiments, the sealing surface may comprise a higher tolerance class with respect to a specific tolerance, may be subject to a surface treatment, comprise a surface coating or another form of a special treatment. The elastomer structure may comprise one or more sealing edges that may also comprise a two-dimensional section adapted to be in contact with the sealing surface.

By implementing the elastomer structure in the described manner, manufacturing and/or resembling of the roller bearing may further be simplified by including a seal. Depending on the implementation, by mechanically fixing the elastomer structure to the retaining flange, the number of parts to be used to assemble the roller bearing may be reduced compared to a conventional implementation. In the case of the elastomer structure being arranged in such a form that it is in contact with a sealing surface of the retaining flange, the sealing properties may eventually be improved by a suitable choice of materials for the retaining flange and the elastomer structure, a suitable surface treatment and/or a suitable surface structure of the sealing surface of the retaining flange. Regardless of the implementation details, by integrating at least parts of the sealing functionality into the retaining flange, manufacturing and/or assembling the roller bearing may further be simplified.

Optionally, in a roller bearing according to an embodiment, the at least one retaining flange may be adapted such that a distance between the at least one retaining flange and the second roller bearing ring does not accede a predetermined value, for instance 2 mm, to shield at least partially a volume between the first and second roller bearing rings from particles entering the volume. In other embodiments, the predetermined value may be, for instance, 1.5 mm, 1 mm or 0.5 mm. In other words, the retaining flange may be additionally used to form a shield preventing particles and other contaminations from entering the inner volume of the roller bearing. As consequence, manufacturing and/or assembling of the roller bearing may be simplified by reducing the number of components to be implemented.

Two objects are adjacent when there is no further object of the same type arranged in between the two objects. Two objects are immediately adjacent to one another, when the respective objects adjoin one another, for instance, by being in contact with one another. A component is integrally formed when it is fabricated from one piece of material. Components being mechanically coupled may be coupled directly or indirectly via a further component. For instance, in the case of rotating objects, a mechanical coupling of the component may comprise the components being torque-proof coupled to one another.

### BRIEF DESCRIPTION OF THE DRAWINGS

Several embodiments of the present invention will be described in the enclosed figures.

FIG. 1 shows a cross-section of a roller bearing according to an embodiment;

FIG. 2 shows an enlarged portion of FIG. 1 showing the retaining flange detachably mounted to the first roller bearing ring in more detail;

FIG. 3 shows the cross-section of the retaining flange in more detail;

FIG. 4 shows a cross-section of a retaining flange with a fastening section in more detail;

FIG. 5 shows a cross-sectional view of a spherical roller bearing;

FIG. 6 shows an enlarged section of FIG. 5 showing the retaining flange of the spherical roller bearing in more detail;

FIG. 7 shows a cross-sectional view of a roller bearing according to an embodiment comprising an elastomer structure adapted to seal the roller bearing;

FIG. 8 shows a cross-sectional view of a roller bearing according to a further embodiment also comprising an elastomer structure mechanically fixed to the retaining flanges of the roller bearing;

FIG. 9 shows a cross-sectional view of a roller bearing according to an embodiment with the retaining flanges adapted to shield an inner volume of the roller bearing from particles entering the volume; and

FIG. 10 shows a flow chart of a method according to an embodiment for assembling a roller bearing according to an embodiment.

### DETAILED DESCRIPTION OF PARTICULAR EMBODIMENTS

In the following, embodiments according to the present invention will be described in more detail. In this context, summarizing reference signs will be used to describe several objects simultaneously all to describe common features, their dimensions, characteristics or the like of these objects. The summarizing reference signs are based on their individual reference signs. Moreover, objects appearing in several embodiments or several figures, but which are identical or at least similar in terms of at least some of their functions or structural features, will be denoted with the same or similar reference signs. To avoid unnecessary repetitions, parts of the description referring to such objects also relate to the corresponding objects of the different embodiments or the different figures, unless explicitly or—taking the context of the description and the figures into account—implicitly stated otherwise. Therefore, similar or related objects may be implemented with at least some identical or similar features, dimensions, and characteristics, but may also be implemented with differing properties.

As outlined before, roller bearings are widely used in mechanical engineering, such as vehicle construction, plant construction and engine construction to name but a few, when a demand exists to guide a rotating component with respect to a stationary one. Moreover, roller bearings are also used when two rotating objects are to be guided with respect to one another. An example of a rotating object being guided with respect to a stationary one is, for instance, a rotating shaft guided with respect to a housing of a machine.

To accommodate the different technical challenges, demands and circumstances, under which a corresponding guidance is required, a great variety of different roller bearing types has been developed. A spherical roller bearing as it will be described in more detail below, represents one example. However, embodiments of a roller bearing, as outlined below, are by far not limited to spherical roller bearings, although the description will focus on this type of roller bearing. Describing embodiments in terms of spherical roller bearing, therefore, merely represents an embodiment. Examples of other types of roller bearings are toroidal roller bearings, tapered roller bearings, spherical thrust roller bearings and cylindrical roller bearings.

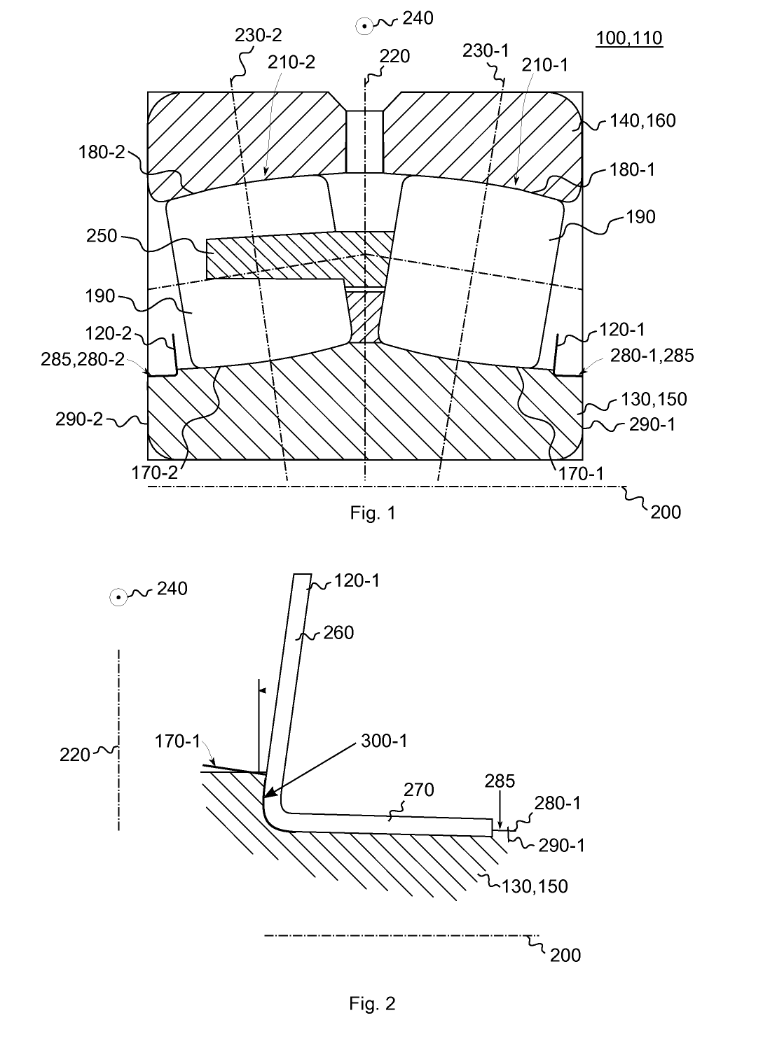

FIG. 1 shows a cross-sectional view of a roller bearing 100 according to an embodiment, which is implemented as a spherical roller bearing 110. To be more precise, as will be laid out below, the spherical roller bearing 110 is a spherical roller bearing of a CA-type comprising retaining flanges 120 which are detachably mounted on an inner ring 130. To be more precise, the spherical roller bearing 110 as shown in FIG. 1 comprises to retaining flanges 120-1, 120-2 which are located at the outer edges of the inner ring 130.

However, although the retaining flanges 120 are detachably or removably mounted to the inner ring 130 in the embodiment shown in FIG. 1, in different embodiments the retaining flanges 120 may also be detachably mounted to an outer ring 140 of the roller bearing 100. Therefore, in the following, the roller bearing ring, onto which the retaining flange 120 is detachably mounted, will be referred to as the first roller bearing ring 150. Accordingly, the roller bearing 100 further comprises a second roller bearing ring 160, which is the outer ring 140 in the embodiment shown in FIG. 1.

Moreover, it should be noted that also the number of retaining flanges 120 implemented may differ in different embodiments. While the embodiment shown in FIG. 1 comprises two retaining flanges 120-2, 120-2, in different embodiments the number may be lower (i.e. one retaining flange 120) or higher (i.e. three, four, five, . . . retaining flanges 120). In other words, with respect to the number of retaining flanges 120, the embodiment shown in FIG. 1 merely represents an exemplified implementation or embodiment.

The first roller bearing ring 150 and the second roller bearing ring 160 each comprise at least one raceway 170, 180, respectively. The plurality of rolling elements 190 is arranged or disposed between the raceways 170, 180 of the first and the second roller bearing rings 150, 160 such that the rolling elements 190 are capable of rolling on the raceways 170, 180 of the two roller bearing rings 150, 160, when the first and second roller bearing rings 150, 160 are turned relatively to one another around an axis 200 of the roller bearing 100. It may be beneficial to use geometries of the raceways 170, 180 which are adapted to the geometries of the rolling elements 190. In the case of a roller bearing 100 as shown in FIG. 1, the rolling elements 190 and the raceways 170, 180 are at least section-wise barrel-shaped or spherically shaped. As consequence, the spherical roller bearing 110 may allow operation even when the axes of the first and second roller bearing rings 150, 160 are slightly misaligned.

Moreover, the roller bearing 100 as shown in FIG. 1 comprises not just a single row 210 of rolling elements 190, but a first row 210-1 and a second row 210-2 of rolling elements 190, which are displaced with respect to one another along the axis 200. Accordingly, the roller bearing rings 150, 160 also each comprise two raceways 170-1, 170-2 and 180-1, 180-2, respectively. The rolling elements 190 and the corresponding raceways 170, 180 are symmetrically arranged with respect to a radial direction 220, which is perpendicular to the axis 200. As shown in FIG. 1, the rolling elements 190 of the rows 210-1, 210-2 are in contact with their respective raceways 170, 180 along lines 230-1, 230-2, respectively, which are symmetrically tilted with respect to the radial direction 220.

However, in other embodiments also the number of rows 210 of rolling elements 190 as well as the type of rolling elements 190 and their arrangement with respect to the axis 200 of the roller bearing 100 may be different. This also applies to other parameters of the roller bearing 100, such as the geometry of the raceways 170, 180.

For the sake of completeness, it should be noted that in the embodiment shown in FIG. 1, the raceways 180-1, 180-2 of the second roller bearing ring 160 (outer ring 140 in FIG. 1) are formed from a common essentially spherical or toroidal surface, while the raceways 170-1, 170-2 of the first roller bearing ring 150 (inner ring 130) are formed from two corresponding spherical or toroidal sections. The raceways 170, 180 may comprise a special surface treatment of or further special surface characteristics, such as a higher tolerance class, a surface hardening, a special coating or another surface treatment.

It should also be noted, that—as outlined before—the association of the first roller bearing ring 150 being the inner ring 130 and the second roller bearing ring 160 being the outer ring 140 may be interchanged in the case of different embodiments of roller bearings 100.

The rolling elements 190 are guided in a circumferential direction 240, which is perpendicular to both the radial direction 220 and the axis 200, by a common cage 250 for both rows 210 of the rolling elements 190. The cage 250 is adapted to separate and space the rolling elements 190 from one another to prevent them from touching. Moreover, the cage 250 also guides the rolling elements 190 with respect to direction inwardly directed from the outer edges of the first and second roller bearing rings 150, 160 along the axis 200. Naturally, in embodiments of a roller bearing also more than one cage 250 or one or more segmented cages 250 may be used.

However, to also guide the rolling elements 190 along the other direction along the axis 200, the roller bearing 100 further comprises the first and second retaining flanges 120 which are adapted to guide the rolling elements 190 along at least one direction of the axis 200 of the roller bearing 100. This direction is the direction from a center of the roller bearing 100 to its outer edges along the axis 200.

The retaining flanges 120 are detachably mounted onto the first roller bearing ring 150. Accordingly, the retaining flanges 120 may be removed and eventually re-installed onto the corresponding roller bearing ring 150. The retaining flanges 120 may be formed as at least one ring segment or a ring having an L-shaped cross-section along a plain perpendicular to the circumferential direction 240 of the roller bearing 100.

To show this in more detail, FIG. 2 shows an enlarged area of the cross-sectional view of FIG. 1 including the first retaining flange 120-1 and a part of the first raceway 170-1 of the first roller bearing ring 150 (inner ring 130). The retaining flange 120 comprises a first section 260 and a second section 270 enclosing an angle with respect to one another between 45° and 135°. In the embodiment shown in FIGS. 1 and 2, the angle between the first and the second sections 260, 270 is approximately 85°, when mounted onto the first roller bearing ring.

The first section 260 which approximately extends along the radial direction 220, is adapted to guide the rolling elements 190, while the second section 270 is adapted to provide the mechanical fixing of the retaining flange 220 with respect to the first roller bearing ring 150. In the embodiment shown in FIGS. 1 and 2, the retaining flange 120 is formed from a bent metal sheet in such way that it is force-fittingly coupled to the first roller bearing ring 150. To enable the force-fitting of the retaining flange 120, allowing a simple assembly process, the first roller bearing ring 150 comprises a recess 280 which is adapted to accommodate the corresponding retaining flange 120. The recess 280 extends from an outer edge 290 of the first roller bearing ring 150 to the raceway 170 of the first roller bearing ring 150. The recess 280 is in this context essentially perpendicularly oriented to the radial direction 220 of the roller bearing 100, yielding a surface 285 to which the retaining flange 120 is force-fittingly coupled.

However, the recess 280 is by far not a mandatory implementation. To be more precise, in a different embodiment, a surface 285 adapted to accommodate the retaining flange 120 may be implemented without implementing a recess 280, for instance, by using a smooth transition at an edge of the raceways 170. The surface 285 may be implemented as a flat surface, a textured surface and/or as a surface comprising structures to facilitate—at least partially—a formfitting coupling.

Due to the shape and form of the raceway 170, the recess 280 provides an edge 300 with respect to the raceway 170 against which the retaining flange 120 is pressed. Therefore, the edge 300 defines a position to which the retaining flange 120 may be pressed during assembly of the roller bearing 100.

It is to be noted that in FIG. 2 the recess 280, the outer edge 290 as well as the edge 300 are all labeled with reference to the first raceway 170-1 of the roller bearing 100. Naturally, also at the opposite outer edge 290-2 of the roller bearing 100, a similar, symmetrically arranged retaining flange 120 is implemented in the case of the roller bearing 100 shown in FIGS. 1 and 2. However, in different embodiments the number of retaining flanges 120 as well as their constructional of implemental details (e.g. symmetry) may differ from one another.

As mentioned before, the retaining flange 120 is formed in the present embodiment from a bent metal sheet. The metal may be any metallic material comprising essentially metallic properties. For instance, a metal is to be understood as a pure metal including appropriate contaminations, an alloy comprising metallic and/or non-metallic components (e.g. steel) or the like. However, in other embodiments the retaining flange may also be formed from a plastic material, for instance suitable for molding or injection molding.

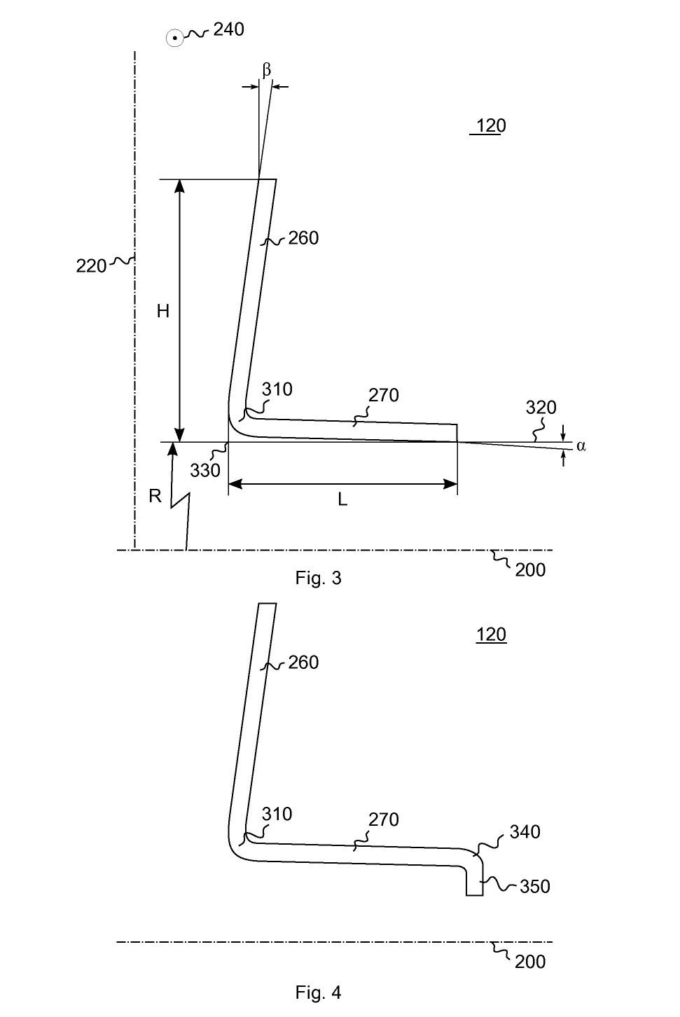

FIG. 3 shows a cross section of retaining flange 120 with its first and second sections 260, 270, respectively. The first and second sections 260, 270 are interconnected by a cross-over section 310 which is bent. In this cross-over section 310 an essentially cylindrical surface 320 is defined which corresponds to the surface of the recess 280 when the retaining flange 120 is detachably mounted onto the first roller bearing ring 150. The second section 170 extends—including a length along the access 200—over a length L, which is slightly tilted downwards compared to the plain 320 by an angle α. As a consequence, when detachably mounting the retaining flange 120 onto the first roller bearing ring 150, the retaining flange 120 exerts a normal force onto the surface of the recess 280 corresponding to the plain 320, when the second section 270 is deformed by the angle α or a fraction thereof. It is this information that excerpts a normal force, which leads to the force-fitting of the retaining flange 120 onto the first roller bearing ring 150.

However, also the first section 260 is slightly tilted with respect to the radial direction 220 by an angle β and comprising a height H—including a height of the cross-over section 310—over the plain 320 corresponding to the surface of the recess 280, when the retaining 120 is mounted onto the first roller bearing ring 150.

In other words, as already laid out in the context of FIG. 2, the retaining flange 120 as used in the embodiments shown in FIGS. 1 and 2, comprises an essentially L-shaped profile in a plain perpendicular to the circumferential direction 240. A cross-over line 330 of the plain 320 and the radial direction 220 in the cross-over section 310 comprises a radius R which corresponds a radius of the recess 280 of the first roller bearing ring 150 as shown in FIGS. 1 and 2.

FIG. 4 shows a cross section of retaining flange 120 with its first and second sections 260, 270, respectively, similar to the cross section of FIG. 3. However, the retaining flange 120 differs from the one shown in FIG. 3 by an additional bent section 340 interconnecting the second section 270 and a fastening section 350, which is adapted to mount the retaining flange 120 on the first roller bearing ring 150 at least partially and to define its mounting position on of the retaining flange 120 along the axial direction. In other words, the fastening section 350, which is bent with respect to the second section 270—in the embodiment shown here—by approximately 90° towards the first roller bearing ring 150, is in contact with a side of the first roller bearing ring 150. Naturally, in other embodiments, details like the actual angle, about which the fastening section 350 is bent with respect to the second section 270, may differ. However, it is often bent away from the second roller bearing ring 160 and towards the first roller bearing ring 150.

However, in different embodiments the retaining flange 120 may also be adhesively coupled to the first roller bearing ring 150. The retaining ring 120 may be, for instance, be glued to the first roller bearing ring 150. In this case, the retaining ring may be removed by dissolving the glue used. The retaining flange 120 may also be form-fittingly coupled to the first roller bearing ring 150.

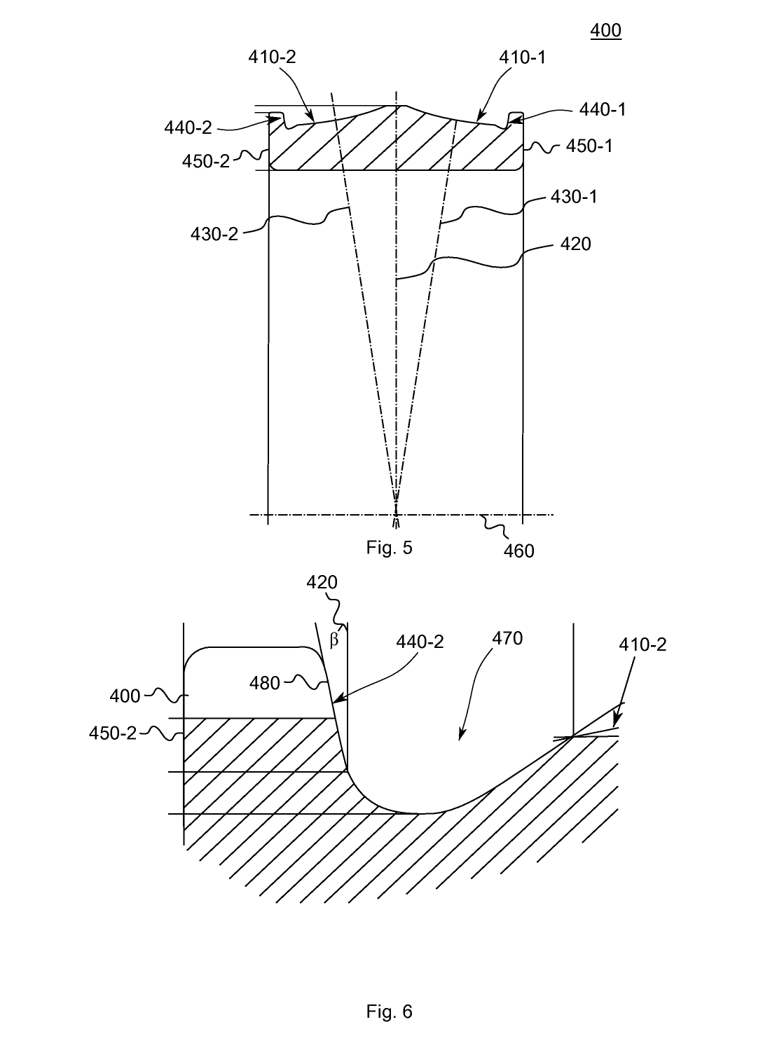

FIG. 5 shows a cross-sectional view of an inner ring 400 of a conventional spherical roller bearing. The inner ring 400 is also configured to accommodate two rows of barrel-shaped rolling elements. However, these are not shown in FIG. 5. However, the inner ring 400 also comprises two raceways 410-1, 410-2 which are oriented with respect to a radial direction 420 by a symmetrical angle as indicated by lines 430-1, 430-2.

The inner ring 400 also comprises retaining flange structures 440-1, 440-2 at both outer edges 450-1, 450-2 of the inner ring 400 along an axis 460 of a conventional spherical roller bearing, respectively.

However, the retaining flange structure 440 of the inner ring 400 of the conventional roller bearing is not detachably mounted onto the inner ring 400, but a part of it. In other words, the retaining flange structures 440 are integrally formed with the inner ring 400 and cannot be removed or detached from the inner ring 400 without destroying it.

FIG. 6 shows the retaining flange structure 440-2 of FIG. 5 in more detail. Starting from raceway 410-2 and moving outwards to the outer edge 450-2 of the inner ring 400, the raceway 410-2 abuts a relieve groove of a recess 470, which intern abuts the retaining flange structure 440-2. The retaining flange structure 440-2 forms an edge 480 having a slope with respect to the radial direction 420 corresponding to an angle β′. The angle β′ and the angle β of the retaining flange 120 as shown in FIG. 3 may be equal, but may also differ, depending on the application in mind. Both at least partially define a point of contact at which the rolling elements, for instance the rolling elements 190 of the embodiments shown in FIGS. 1 and 2, come into contact with the retaining flange structure 440 and the retaining flange 120, respectively.

However, to allow the rolling elements in the conventional spherical roller bearing a defined point of contact with the retaining flange structure 440, the relief groove 470 is included into the design of the conventional inner ring 400. As a consequence, manufacturing the inner ring 400 of the conventional spherical roller bearing requires not only integrating the retaining flange structure 440 into the inner ring 400, but also the implementation of the relief groove 470 adjacent to the retaining flange structure 440.

In contrast, the first roller bearing ring 150 of a roller bearing 100 according to an embodiment can be implemented relieve groove-free because of the implementation of the retaining flange 120 as a detachable component. As a consequence of this implementation, a natural groove arises which prevents the rolling elements 190 of a roller bearing 100 according to an embodiment to get into contact with the retaining flange 120, for instance, at its lower portions. In the embodiment shown in FIGS. 1 and 2, this is supported by creating the edges 300 adjacent to the raceways 170 of the first roller bearing ring 150.

Moreover, also the manufacturing itself may be simplified since that may eventually be avoided, which are conventionally to be integrated into the manufacturing process of the inner ring 400. Furthermore, assembling the roller bearing 100 may also be simplifyable since the rolling elements 190 do not have to be mounted with the retaining flange structure 440 or rather the retaining flange 120 in place. Therefore, a volume between the first and second roller bearing rings 150, 160 may be more easily accessible in a roller bearing 100 according to an embodiment because the retaining flanges 120 do not have to be installed prior to including the rolling elements 190.

In other words, by removing the CA-flange in the case of a spherical roller bearing 110 of the CA-type costs may be saved by simplifying the manufacturing and assembly process. For instance, the steps of handling the material of the first roller bearing ring 150 may be simplified compared to the conventional inner ring 400 in the steps of soft mashing and/or hard turning of the material. Moreover, as laid out before, assembling the roller bearing 100 according to an embodiment may be simplified during the manufacturing process.

As will be laid out below, by implementing a loose or detachable retaining flange 120 (e.g. CA-flange) may also provide new opportunities. For instance, the retaining flange 120 may serve as a sealing surface. In many cases it may be advisable to let a sealing structure such as an elastomer structure run against a stainless steel surface. As a consequence, the retaining flange 120 may easily be produced from a stainless steel sheet. Optionally, the retaining flange 120 may also comprise a surface finish in the area of the sealing surface, which, however, is by far not a required detail.

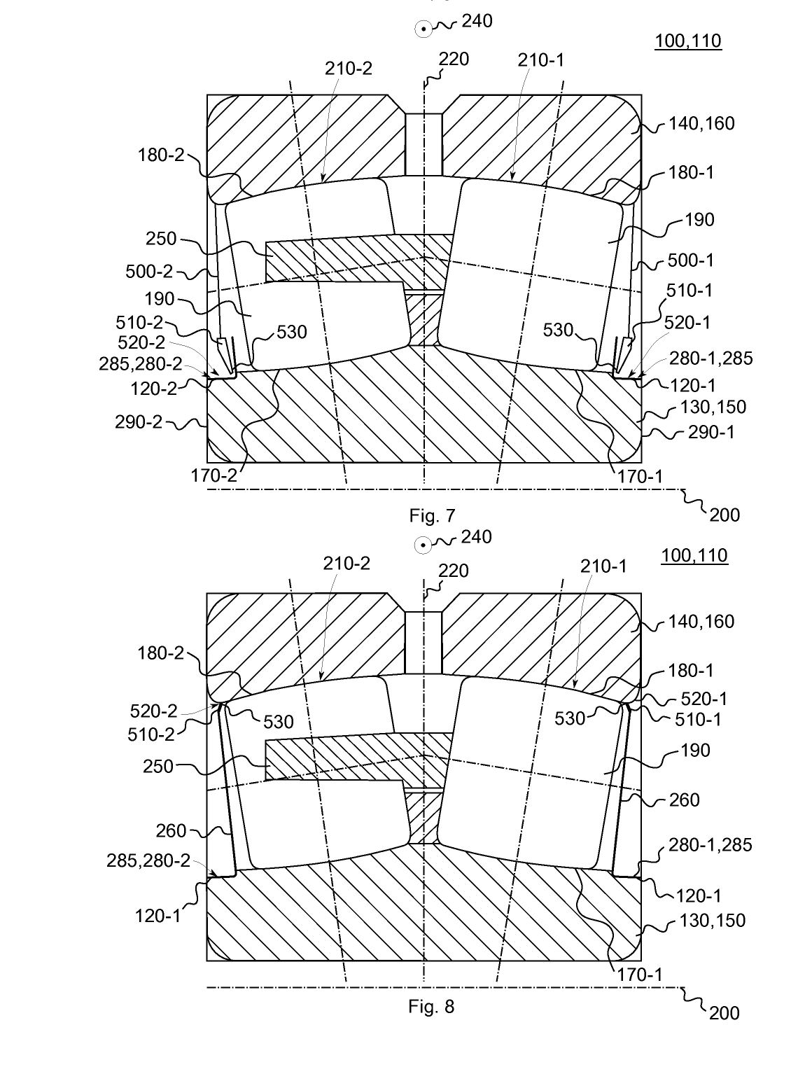

FIG. 7 shows a cross-sectional view of a roller bearing 100 in the form of a spherical roller bearing 110 according to an embodiment in sealed version. The roller bearing 100 as shown in FIG. 7 differs from the roller bearing shown in FIGS. 1 and 2 mainly with respect to an additional seal 500-1 at the first outer edge 290-1 and a second seal 500-2 at the second outer edge 290-2. The seals 500 each comprise an elastomer structure 510-1, 510-2, respectively, which are mechanically fixed to the second roller bearing ring 160, which is in the embodiment shown in FIG. 7 the outer ring 140. The elastomer structure 510-1 and 510-2 are in contact with the sealing surfaces 520-1, 520-2, respectively, which are located at the backside of the second sections 270 of the retaining flanges 120 facing away from the first roller bearing ring 150. In other words, the elastomer structures 510 are in contact with the backside of the second sections 270 of the retaining flanges 120.

For instance, in some embodiments it may be beneficial, to implement the retaining flange 120 based on a stainless steel sheet so that the elastomer structures 510 are in contact with the sealing surfaces 520 made of stainless steel. Naturally, as a further option, the sealing surfaces 520 may be surface treated, for instance, by a surface hardening or another appropriate treatment, such as a coating, implementing a specific structure of the like.

In FIG. 7 the elastomer structures 510 are shown to comprise sealing edges 530, with which the elastomer structures 510 are in contact with the sealing surfaces 520. However, in other embodiments the elastomer structures 510 may additionally or alternatively comprise a two-dimensional structure adapted to be in contact with the sealing surfaces 520.

FIG. 8 shows a cross-sectional view of a further roller bearing according to an embodiment implemented as a spherical roller bearing 110. The roller bearing 100 as shown in FIG. 8 differs from the one shown in FIG. 1 mainly with respect to the implementation of the retaining flanges 120. While the retaining flanges 120 of FIG. 1 extend along the radial direction 220 only along a small fraction of a distance between the first and second roller bearing rings 150, 160, in the case of a roller bearing 100 as shown in FIG. 8, the first sections 260 of the retaining flanges 120 extends over a significant amount of the distance between the two roller bearing rings 150, 160.

Moreover, at the radially outward end of the first sections 260 of the retaining flanges 120, elastomer structures 510-1, 510-2 are integrated as sealing lips or sealing edges 530. The sealing edges 530 of the elastomer structures 510 are in contact with sealing surfaces 520-1, 520-2, which are located on the second roller bearing ring 160. In other words, in contrast to the seals 500 of the roller bearing 100 as shown in FIG. 7, the elastomer structures 510 are mechanically coupled via the retaining flanges 120 to the first roller bearing ring 150. Accordingly, the sealing surfaces 520, with which the sealing lips or sealing edges 530 of the elastomer structures 510 are in contact, are arranged at the second roller bearing ring 160.

As outlined before, the sealing surfaces 520 may be subjected to an additional surface treatment, which is, however, by far not necessary. This nearly represents an option.

The elastomer structures 510 are mechanically fixed to the retaining flanges 120. This may be achieved, for instance, by an adhesively bonding, achieved by adhesively bonding same to the retaining flanges 120. For instance, the elastomer structures 510 may be glued or vulcanized to the retaining flanges 120. Naturally, also other adhesive bonding techniques or other techniques for mechanically fixing the elastomer structure to the retaining flanges 120 may be employed.

In other words, FIG. 8 shows an embodiment of a roller bearing 100 with retaining flanges 120 which are also equipped with a sealing lip or a sealing edge 530 so that the roller bearing 100 can be implemented as a sealed bearing.

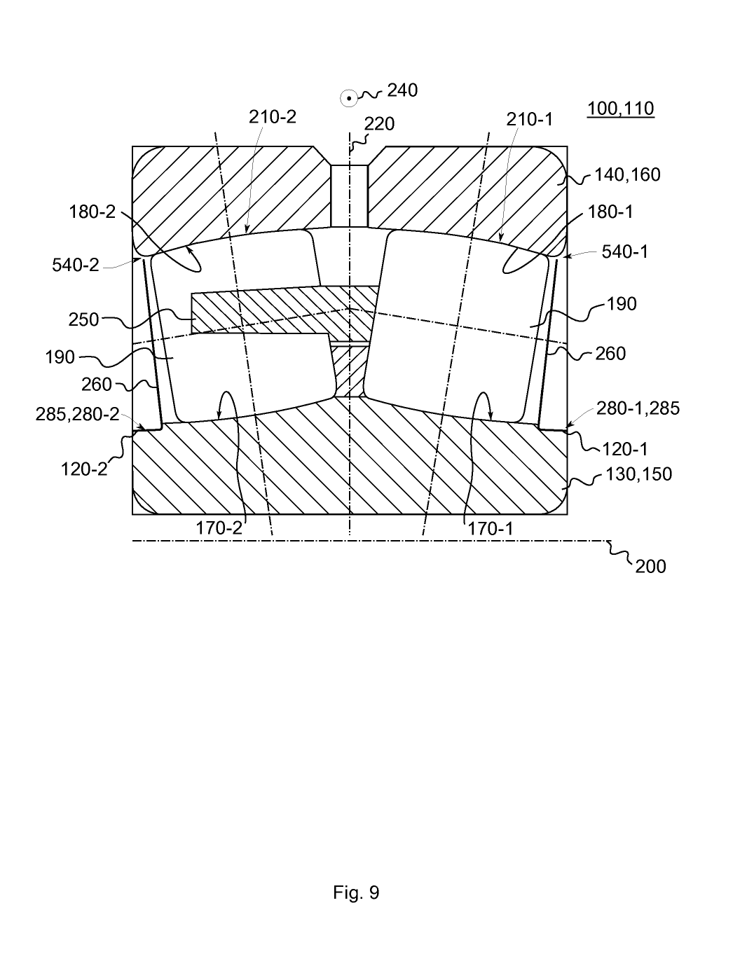

FIG. 9 shows a cross-sectional view of a roller bearing 100 according to an embodiment implemented as a spherical roller bearing 110. The roller bearing 100 of FIG. 9 differs from the one shown in FIGS. 1 and 2 mainly with respect to the extension of the first sections 260 of the retaining flanges 120 along the radial direction 220. While in FIG. 1 the first sections 260 of the retaining flanges 120 merely extend to such an extent that the rolling elements 190 are capable of being guided by the retaining flanges 120, the retaining flanges 120 as shown in FIG. 9 extend almost fully to the second roller bearing ring 160.

To be a little more specific, the retaining flanges 120 extend towards the second roller bearing rings 160 to such an extent that between a radially outward edge of the retaining flanges 120 and the second roller bearing ring 160 a first gap or a distance 540-1 between the first retaining flange 120 and the second roller bearing ring 160 and a second gap or distance 540-2 between the second retaining flange 120-2 and second roller bearing ring 160 exists. The distances 540 between the retaining flanges 120 and the second roller bearing 160, however, do not exceed a predetermined value, which, for instance, may be 2 mm. As a consequence, the retaining flanges 120 also work in this embodiment as a shield to protect the bearing from contaminations or particles entering the volume between the first and second roller bearing rings 150, 160. In other words, the retaining flanges 120 of the roller bearing 100 as shown in FIG. 9 are operable to shield the inner volume of the roller bearing 100 to prevent particles and other contaminations from entering the roller bearing 100. Moreover, the retaining flanges 120 can also work as cooling discs if necessary or advisable.

However, it should be noted that although in the previously described embodiments always two retaining flanges 120 have been used, the number of retaining flanges 120 can be either higher or lower. In other words, an embodiment of a roller bearing 100 may also comprise just a single retaining flange, but also three, four or more. Moreover, in the case of more than one retaining flange 120 being implemented, the retaining flanges 120 may implemented differently. In other words, for instance, a retaining flange 120 arranged to face an inner part of a machine may be implemented without an additional sealing or shielding capability, while an outer retaining flange 120 may be one adapted to shield or to seal the volume of the roller bearing 100.

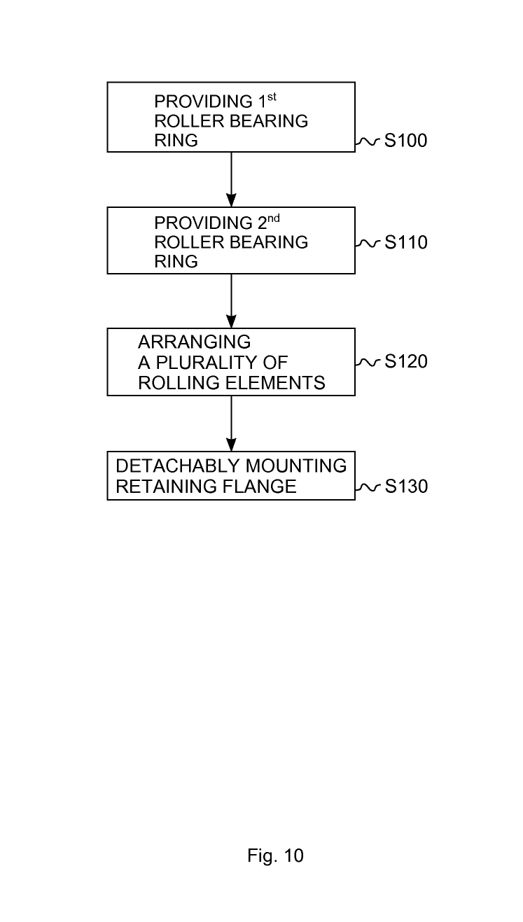

FIG. 10 shows a flow chart of a method according to an embodiment for assembling a roller bearing. In a step S100 the first roller bearing ring 150 is provided, that comprises at least one raceway. In a step S110 the second roller bearing ring 160 comprising at least one raceway 180 is provided. In a step S120 a plurality of rolling elements 190 is arranged between the raceways 170, 180 of the first and second roller bearing rings 150, 160. Finally, in a step S130 the at least one retaining flange 120 is detachably mounted onto the first roller bearing ring 150.

It should be noted that the steps as described in context with FIG. 10 do not necessarily represent an order of the steps. In other words, the steps as described may also be carried out in a different order and/or timely overlapping or simultaneously. However, it may be advisable to facilitate an easier assembly of the roller bearing 100 according to an embodiment to mount the retaining flange 120 in a final step after arranging the plurality of rolling elements 190 in step S120.

Employing an embodiment may simplify manufacturing and/or assembling the roller bearing 100.

The description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

Functional blocks denoted as “means for . . . ” (performing a certain function) shall be understood as functional blocks comprising circuitry that is adapted for performing or to perform a certain function, respectively. Hence, a “means for s.th.” may as well be understood as a “means being adapted or suited for s.th.”. A means being adapted for performing a certain function does, hence, not imply that such means necessarily is performing said function (at a given time instant).

Furthermore, the following claims are hereby incorporated into the Detailed Description, where each claim may stand on its own as a separate embodiment. While each claim may stand on its own as a separate embodiment, it is to be noted that—although a dependent claim may refer in the claims to a specific combination with one or more other claims—other embodiments may also include a combination of the dependent claim with the subject matter of each other dependent claim. Such combinations are proposed herein unless it is stated that a specific combination is not intended. Furthermore, it is intended to include also features of a claim to any other independent claim even if this claim is not directly made dependent to the independent claim.

It is further to be noted that methods disclosed in the specification or in the claims may be implemented by a device having means for performing each of the respective steps of these methods.

Further, it is to be understood that the disclosure of multiple steps or functions disclosed in the specification or claims may not be construed as to be within the specific order. Therefore, the disclosure of multiple steps or functions will not limit these to a particular order unless such steps or functions are not interchangeable for technical reasons.

Furthermore, in some embodiments a single step may include or may be broken into multiple sub-steps. Such sub-steps may be included and part of the disclosure of this single step unless explicitly excluded.

### LIST OF REFERENCE SIGNS

100 roller bearing
110 spherical roller bearing
120 retaining flange
130 inner ring
140 outer ring
150 first roller bearing ring
160 second roller bearing ring
170 raceway
180 raceway
190 rolling element
200 axis
210 row
220 radial direction
230 line
240 circumferential direction
250 cage
260 first section
270 second section
280 recess
285 surface
290 outer edge
300 edge
310 cross-over section
320 surface
330 cross-over line
340 bent section
350 fastening section
400 inner ring
410 raceway
420 radial direction
430 line
440 retaining flange structure
450 outer edge
460 axis
470 relief groove
480 edge
500 seal
510 elastomer structure
520 sealing surface
530 sealing edge
540 distance
S100 providing first roller bearing ring
S110 providing second roller bearing ring
S120 arranging plurality of rolling elements
S130 detachably mounting retaining flange

1. A roller bearing comprising:
a first roller bearing ring including at least one raceway;
a second roller bearing ring including at least one raceway;
a plurality of rolling elements arranged between the raceways of the first roller bearing ring and the second roller bearing ring; and
at least one retaining flange detachably mounted onto the first roller bearing ring.

2. The roller bearing according to claim 1, wherein the at least one retaining flange comprises one of:
(a) at least one ring segment or
(b) a ring having a L-shaped cross-section along a plain perpendicular to a circumferential direction of the roller bearing.

3. The roller bearing according to claim 1, wherein the at least one retaining flange is formed from one of:
(a) a bent metal sheet or
(b) a plastic material.

4. The roller bearing according to claim 1, wherein the at least one retaining flange is at least one of force-fittingly, form-fittingly and adhesively coupled to the first roller bearing ring.

5. The roller bearing according to claim 4, wherein the first roller bearing ring comprises at least one surface adapted to accommodate the at least one retaining flange.

6. The roller bearing according to claim 5, wherein at least one of:
(a) the at least one surface is formed in a recess extending from an outer edge of the first roller bearing ring to the raceway of the first roller bearing ring, and
(b) the at least one surface is essentially oriented perpendicular to a radial direction of the roller bearing.

7. The roller bearing according to claim 1, wherein the first roller bearing ring and second roller bearing ring comprise each at least two raceways, and wherein the plurality of rolling elements is arranged between each of the at least two raceways of the first roller bearing ring and second roller bearing ring.

8. The roller bearing according to claim 1, further comprising at least one elastomer structure adapted to seal at least partially a volume between the first and second roller bearing rings, wherein at least one of:
(a) the at least one elastomer structure is mechanically fixed to the second roller bearing ring and in contact with a sealing surface of the at least one retaining flange, and
(b) the at least one elastomer structure is mechanically fixed to the at least one retaining flange and adapted to be in contact with a sealing surface of the second roller bearing ring.

9. The roller bearing according to claim 1, wherein the at least one retaining flange is adapted such that a distance between the at least one retaining flange and the second roller bearing ring does not exceed a predetermined value to shield at least partially a volume between the first and second roller bearing rings from particles entering the volume.

10. A method for assembling a roller bearing, comprising:
providing a first roller bearing ring including at least one raceway;
providing a second roller bearing ring including at least one raceway;
arranging (S120) a plurality of rolling elements between the raceways of the first roller bearing ring and the second roller bearing ring; and
detachably mounting at least one retaining flange onto the first roller bearing ring.

11. The roller bearing according to claim 1, wherein the at least one retaining flange is adhesively coupled by gluing to the first roller bearing ring.

12. The roller bearing according to claim 1, further comprising at least one elastomer structure adapted to seal at least partially a volume between the first and second roller bearing rings, wherein at least one of:
(a) the at least one elastomer structure is mechanically fixed to the second roller bearing ring and in contact with a sealing surface of the at least one retaining flange, and
(b) the at least one elastomer structure is mechanically fixed by an adhesively bonding to the at least one retaining flange and adapted to be in contact with a sealing surface of the second roller bearing ring.

13. The roller bearing according to claim 1, wherein the at least one retaining flange is adapted such that a distance between the at least one retaining flange and the second roller bearing ring does not exceed 2 mm to shield at least partially a volume between the first and second roller bearing rings from particles entering the volume.
